(19) United States
(12) Patent Application Publication
(10) Pub. No.: US 2021/0127034 A1
(43) Pub. Date: Apr. 29, 2021

(54) HALFTONE SCREENS

(71) Applicant: HEWLETT-PACKARD DEVELOPMENT COMPANY, L.P., Spring, TX (US)

(72) Inventors: Tal Frank, Ness Ziona (IL); Oren Haik, Ness Ziona (IL); Yotam Ben-Shoshan, Ness Ziona (IL)

(21) Appl. No.: 16/605,845

(22) PCT Filed: Mar. 28, 2018
(86) PCT No.: PCT/US2018/024941

§ 371 Date: Oct. 17, 2019

(51) Int. Cl. H04N 1/405; H04N 1/56

(52) U.S. Cl. CPC H04N 1/4058; H04N 1/56

(57) ABSTRACT

A method comprises forming a halftone screen set comprising first, second and third halftone screens. A first regular halftone screen for the screen set is selected. A second regular halftone screen is determined, using a processor, by performing a regularity invariant transformation on the first regular halftone screen. A third halftone screen is determined based on at least one predetermined condition being satisfied between the first, second and third halftone screens.

### BACKGROUND

Printers are generally unable to adjust the color or color intensity or gray level of printing fluid delivered to a medium. To produce the appearance of a wide printed color gamut, with variations in the color intensity, the size or spacing of printed dots may be varied. Where the size of printed dots is varied this may be referred to as ‘amplitude modulation’. Where the spacing of printing dots is varied, this may be referred to as ‘frequency modulation’. The human eye may interpret small dots or largely spaced dots as having a lesser color intensity than large dots or dots with small spacing. In an example, the printer may print dots with fixed sizes, but the printer may vary how many dots are printed in cells with predetermined sizes. The apparent color intensity of a cell may be proportional to how many dots are printed in the cell.

### BRIEF DESCRIPTION OF THE DRAWINGS

Various features of the present disclosure will be apparent from the detailed description which follows, taken in conjunction with the accompanying drawings, which together illustrate features of the present disclosure, and wherein:

FIG. 1 is a block diagram of an example system to convert an image to a plurality of halftone images based on a plurality of halftone screens.

FIG. 2 is a block diagram of another example system to convert an image to a plurality of halftone images based on a plurality of halftone screens.

FIG. 3 is a flow diagram of an example method to generate a plurality of halftone screens.

FIG. 4 is a flow diagram of another example method to generate a plurality of halftone screens.

FIG. 5 is a block diagram of an example computer-readable medium including instructions that cause a processor to generate a plurality of halftone images based on a plurality of halftone screens.

FIG. 6 is a block diagram of another example computer-readable medium including instructions that cause a processor to generate a plurality of halftone images based on a plurality of halftone screens.

FIGS. 7a, 7b and 7c show example regular and irregular halftone screens.

### DETAILED DESCRIPTION

A halftone screen may specify the locations and sizes of cells used to produce halftone representations of color intensities or gray levels. In an example, a printer may be able to print dots at predetermined locations. For any dot, the nearest neighboring dots may be located in two orthogonal directions. Accordingly, the dots may form a grid. The cells in a halftone screen may also form an orthogonal grid. The cell grid and the dot grid may be aligned with each other, or the cell grid may be rotated relative to the dot grid. The locations and sizes of cells in a halftone screen may be indicated by a number of lines per inch and a screen angle relative to the dot grid.

As used herein, the term “dot” refers to the smallest element that can be printed by a particular printer. The term “cell” refers to a plurality of dots used to produce a halftone representation of a color intensity or gray level. The terms “dot grid” and “cell grid” refer to the grids that would be created by drawing lines connecting centers of all printable dots or all cells in a halftone screen, respectively. The angle of the cell grid relative to the dot grid is referred to herein as the “screen angle.” The angle of the dot grid as described herein is denoted as 0 degrees. The term “lines per inch” (LPI) refers to the number of cells that can be printed per inch when traveling along a cell gridline. The term “dots per inch” (DPI) refers to the number of dots that can be printed per inch when traveling along a dot gridline. As used herein, the term “halftone screen” refers to data or a mechanical screen that specifies or determines the locations of cells. A plurality of halftone screens for printing a plurality of colors is referred to herein as a “halftone screen set” or “screen set.” The printer may be a two-dimensional (2D) or three-dimensional (3D) printer to produce a 2D or 3D print, and the dots and cells may be 2D or 3D. The screen angle may include a single component or multiple components. In examples, the screen is used for amplitude modulation printing.

For a polychromatic printer, there may be a halftone screen for each color. When the screens for the different colors are overlaid on each other, the relative locations of cells in the different halftone screens may vary periodically and create moiré patterns noticeable to a viewer. In some examples, the halftone screens of a four-color printing system may have a same LPI and be positioned at angles of approximately 0, 15, 45, and 75 degrees. In such an arrangement, the halftone screens form circular rosette structures, where a rosette is the repeating pattern formed by the halftone cells of the halftone screens. The rosette structures produce a rosette moiré, which viewers do not find as objectionable as other moiré patterns. The repetitive structure of the rosettes may create a smooth print. As used herein, the term “smooth” refers to screen sets that produce prints with low graininess/granularity.

The variations in LPI or screen angles may be selected to produce a high frequency moiré pattern. The frequency of the moiré pattern may be high enough that the moiré pattern will not be perceived by a viewer. For example, the frequency of the moiré pattern may be at least 40 LPI, 60 LPI, 70 LPI, 80 LPI, 85 LPI, 90 LPI, 100 LPI, or the like. In an example, the frequency of the moiré pattern may be at least around 127 LPI, equivalent to a frequency of approximately 1/0.2 mm.

Halftone screens having high LPI values may be perceived as producing an increased sharpness or smoothness in an image when compared with halftone screen comprising lower LPI values. However, at higher LPI values, for a given DPI value, there may be fewer screens available which are regular screens—that is, screens which have a low value for their regularity index, as will be discussed in more detail below. The use of irregular screens when attempting to use high LPI screens results therefore may result in increased quantization noise in an image, as will be discussed in more detail below. As such, obtaining a screen set comprising halftone screens with high LPI values and with a high degree of regularity can provide for a halftone screen set able to produce sharp, smooth images with low amounts of quantization noise.

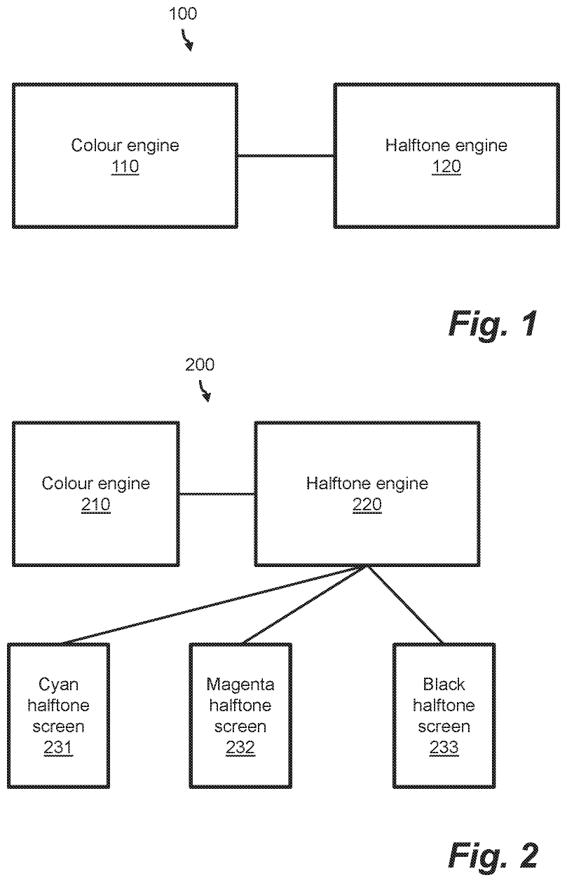

FIG. 1 is a block diagram of an example system 100 to convert an image to a plurality of halftone images based on a plurality of halftone screens. The system 100 may include a color engine 110. The color engine 110 may separate the image into a plurality of color components of the image. In some examples, the color engine 110 may convert the image from a first color space to a second color space. The color engine 110 may extract the color intensity of each color in the final color space for each pixel to produce the color component corresponding to that color. As used herein, the term “engine” refers to hardware, e.g., a processor, such as an integrated circuit, or analog or digital circuitry, or a combination of machine-readable instructions, e.g., programming such as machine- or processor-executable instructions, commands, or code such as firmware, a device driver, programming, object code, etc., and hardware. Hardware includes a hardware element with no machine instruction elements, such as an application specific integrated circuit (ASIC), a Field Programmable Gate Array (FPGA), etc. A combination of hardware and machine-readable instructions includes machine-readable instructions hosted at hardware e.g., a module that is stored at a processor-readable memory, such as random-access memory (RAM), a hard-disk or solid-state drive, resistive memory, or optical media such as a digital versatile disc (DVD), or executed or interpreted by a processor, or hardware and machine-readable instructions hosted at hardware.

The system 100 may also include a halftone engine 120. The halftone engine 120 may generate a plurality of halftone images based on the plurality of color components and a plurality of halftone screens. The halftone engine 120 may use a halftone screen to determine cell locations. The halftone engine 120 may determine a color intensity for each cell location based on the color component corresponding to the halftone screen. The halftone engine 120 may generate a halftone representation of each determined color intensity for the corresponding cell location. The halftone engine 120 may generate the halftone image from the halftone representations for each cell location.

In examples herein, the halftone screen set is an amplitude modulation halftone screen set. In an example, a first halftone screen in the plurality of halftone screens has cell centers that occur at regular distances relative to a dot pitch and has cell centers that are aligned with a dot pitch. A halftone screen with cell centers that occur at regular distances relative to a dot pitch and has cell centers that are aligned with a dot pitch may be referred to as a “regular” halftone screen. In an example a second halftone screen in the plurality of halftone screens has cell centers that occur at regular distances relative to a dot pitch and cell centers that are aligned with a dot pitch and is a regular halftone screen. As used herein, the term “dot pitch” refers to the distance between adjacent dots along a dot gridline. The dot pitch may be the inverse of the DPI. The dot pitch may be that of a printer for which the halftone images are generated. In some examples, one or more of the screens may have cell centers that occur at regular distance or semi-regular distances to a dot-pitch. As used herein, the term “semi-regular distances” refers to distances for which the ratio of the distance between adjacent cell centers to the dot pitch is a rational number with a small denominator (e.g., a denominator less than or equal to 2, 4, 5, 10, 20, or the like). As used herein, the term “regular distance” refers to distances for which the ratio of the distance between adjacent cell centers to the dot pitch is a rational number with a denominator equal to one. Cell centers may occur at a regular or semi-regular distance if the distance between cell centers along each dimension of the dot grid is a regular or semi-regular distance even though the absolute distance is not a regular or semi-regular distance. Alternatively, or in addition, the absolute distance between cell centers may be a regular or semi-regular distance. The cells may be symmetrical, so the cell edges, cell corners, etc. may also occur at regular or semi-regular distances relative to the dot pitch. Halftone screens with cell centers that occur at regular or semi-regular distances may be smoother than halftone screen with cell centers that do not occur at regular or semi-regular distances.

Halftone screens which are not regular may be referred to as irregular screens. Irregular screens may have halftone cell centers which are not at a dot position in the dot grid. This may result in quantization frequencies when an irregular screen is printed. Such quantization frequencies may result in visible noise in an image. The noise in an irregular image may be proportional to a ratio between the halftone cell size and a quantization distance. That is, the noise in an irregular image may be proportional to the distance of the halftone cell center to the ideal cell center of the closest available dot. An increase in LPI of a screen may be considered to be equivalent to decreasing the size of the halftone cells of the screen. Quantization noise for a screen may increase as the LPI of a screen increases relative to the DPI of the dot pitch, since increasing the LPI relative to the DPI increases the distance of the average cell center to a dot of the dot pitch.

The plurality of halftone screens may form a high frequency moiré pattern when the halftone screens are overlaid on each other. The plurality of halftone screens may be selected so the high frequency moiré pattern is not visible to viewers. For example, the LPI and screen angle of each screen may be selected so the interference pattern produced by the overlaid screens includes frequency components above a predetermined threshold. Accordingly, the plurality of halftone screens making up the screen set may be smooth, due to each having a low value for their regularity index. The regularity index will be defined below.

FIG. 2 is a block diagram of another example system 200 to convert an image to a plurality of halftone images based on a plurality of halftone screens 231-233. The system 200 may include a color engine 210 to separate an image into a plurality of color components. The system 200 may also include a halftone engine 220 to generate a plurality of halftone images based on the plurality of color components and the plurality of halftone screens 231-233. In the illustrated example, the system 200 includes a cyan halftone screen 231, a magenta halftone screen 232 and a black halftone screen 233. In some examples, the system 200 may include four halftone screens, for example a cyan halftone screen, a magenta halftone screen, a black halftone screen, and a yellow halftone screen. In some examples, the system may contain more or fewer halftone screens and may include halftone screens for colors besides cyan, magenta and black and colors besides cyan, magenta, black and yellow.

In an example, the first halftone screen 231 is a cyan halftone screen and is a regular halftone screen. In an example, the second halftone screen is a magenta halftone screen 232, and is a regular halftone screen. That is, in this example, the first halftone screen 231 and the second halftone screen 232 both have a regularity index equal to 1. Each halftone screen 231-233 may have a regularity index less than or equal to a predetermined threshold. For example, a third halftone screen, e.g. black halftone screen 233, may have a regularity index below a predetermined threshold which may be for example 2,6,8, or 10. In one example, the third halftone screen has a regularity index less than or equal to 10. The regularity index of a halftone screen may be determined based on basis vectors for the halftone screen. The basis vectors may be vectors from a center of a cell in the halftone screen to centers of the cell's nearest neighbors. Cartesian representations of the basis vectors relative to the dot grid may be determined. For example, basis vectors of a 2D halftone screen may be specified in Cartesian form using the equations:

$$\begin{matrix}{\vec{n}}_{1}^{i} = \frac{D P I}{L P {I}_{j}} ( cos {ϕ}_{i} , sin {ϕ}_{i} ) = Ce l l S i z {e}_{i} ( cos {ϕ}_{i} , sin {ϕ}_{i} ) & ( 1 ) \\ {\vec{n}}_{2}^{i} = \frac{D P I}{L P {I}_{j}} ( - sin {ϕ}_{i} , cos {ϕ}_{i} ) = C e l l S i z {e}_{i} ( - sin {ϕ}_{i} , cos {ϕ}_{i} ) & ( 2 )\end{matrix}$$

Where i is an index indicating the particular halftone screen, [symbol] and [symbol] are the basis vectors, and ϕᵢ is the screen angle. The cell size is defined in equations 1 and 2 as the ratio between the DPI of the dot grid and the LPI of the halftone screen.

In some examples, the basis vectors may be expressed as rational numbers. For example, the basis vectors may be expressed according to the equations:

$${\vec{n}}_{1}^{i} = ( \frac{{p}_{1}^{i}}{{q}_{1}^{i}} , \frac{{p}_{2}^{i}}{{q}_{2}^{i}} ) ; {\vec{n}}_{2}^{i} = ( - \frac{{p}_{2}^{i}}{{q}_{2}^{i}} , \frac{{p}_{1}^{i}}{{q}_{1}^{i}} ) \qquad ( 3 )$$

Where p₁, p₂, q₁, q₂ are restricted to the integers. The regularity index of the halftone screen may be determined based on a least common multiple of the denominators of each component of the basis vectors. In this example, the denominators may be the same for both basis vectors but rearranged among components, so the regularity index may be computed based on the least common multiple of the denominators of one basis vector. In an example, the regularity index may be computed according to the equation:

Regularity Indexᵢ=lcm(q₁ⁱ,q₂ⁱ) (4)

Where lcm is a function that outputs the least common multiple. In examples herein, a regular halftone screen is defined such that the components of the basis vectors defining the screen are integers.

The regularity index of each halftone screen 231-233 may correspond inversely with the smoothness and directly with the graininess/granularity. For example, a halftone screen with a regularity index of 100 may not be smooth, but halftone screens with regularity indexes less than or equal to 1, 2, 4, 5, 10, 20, etc. may be smooth. In an example, the first screen 231 and the second screen 232 are regular screens and have a regularity index equal to 1. In other examples, two of the plurality of halftone screens may have a regularity index of 1. In an example, if one or more of the halftone screens 231-233 has a regularity index which is different to the regularity index of the other screens, a color for which viewers have a lower sensitivity to granularity may be selected to have a higher regularity index. The black halftone screen 233 may be selected to have the higher regularity index in an example. Similarly, a color for which viewers have a higher sensitivity to granularity may be selected to have a lower regularity index. For example, the cyan screen 231 and the magenta screen 233 may be selected to be the regular screens. This may be, for example, to allow smooth reproduction of colors used in producing skin tones or sky tones in an image.

Each halftone screen 231-233 may be selected so that magnitudes of all moiré frequency vectors for each of a plurality of moiré orders are greater than or at least equal to a corresponding minimum frequency. A frequency vector may indicate how often cells in a halftone screen repeat and the direction of that repetition. Each halftone screen 231-233 may have a plurality of frequency vectors. For example, the fundamental frequency vectors of a 2D halftone screen may be specified by the equations:

$$\begin{matrix}{\vec{f}}_{1}^{i} = \frac{{LPI}_{i}}{DPI} ( cos {ϕ}_{i} , sin {ϕ}_{i} ) = \frac{1}{C e l l S i z e} ( cos {ϕ}_{i} , sin {ϕ}_{i} ) & ( 5 ) \\ {\vec{f}}_{2}^{i} = \frac{{LPI}_{i}}{DPI} ( - sin {ϕ}_{i} , cos {ϕ}_{i} ) = \frac{1}{C e l l S i z e} ( - sin {ϕ}_{i} , cos {ϕ}_{i} ) & ( 6 )\end{matrix}$$

Where i and ϕᵢ have the same meaning as in equations 1 and 2 and [symbol] and [symbol] are the fundamental frequency vectors.

A moiré frequency vector may be computed by adding together fundamental frequency vectors from the plurality of halftone screens 231-233. In some examples a moiré frequency vector may be calculated taking into account any other halftone screen in the screen set, for example a yellow halftone screen. The fundamental frequency vectors may be multiplied by integer coefficients when computing the moiré frequency vector. The moiré order of a moiré frequency vector may be the sum of the absolute values of the integer coefficients. For any moiré order, all moiré frequency vectors of that or a lesser order may be computed, for example, by selecting all possible combinations of integer coefficients for each moiré order. The magnitudes of the moiré frequency vectors may be compared to the minimum frequency for that moiré order to determine if the moiré frequency vectors are greater than or at least the minimum frequency.

For example, the moiré frequency vector may be compared to the minimum frequency according to the equation:

$$‖ {\vec{f}}_{moire} ‖ = ‖ {\sum }_{i , j} {α}_{j}^{i} {\vec{f}}_{i}^{i} ‖ > {f}_{min} \qquad ( 7 )$$

Where [symbol] is the moiré frequency vector, i is an index indicating the particular halftone screen, j is an index indicating the particular fundamental frequency vector for that halftone screen, [symbol] is the fundamental frequency vector indicated by the index values, αⱼⁱ is the integer coefficient for the fundamental frequency vector indicated by the index values, and fₘᵢₙ is the minimum frequency. The magnitude of the moiré frequency vector is referred to herein as the “moiré frequency.” In an example, equation 7 may be computed for all integer coefficients that satisfy the equation:

$${\sum }_{i , j} \vert {α}_{j}^{i} \vert < {O}_{max} \qquad ( 8 )$$

Where i, j, and αⱼⁱ have the same meaning as in equation 7 and Oₘₐₓ is the maximum moiré order, a cutoff above which moiré patterns are not noticeable to viewers. The maximum moiré order may be four, five, six, seven, eight, nine, etc. in some examples. In an example, the halftone screens 231-234 are selected so that magnitudes of all moiré frequency vectors for each of the first six moiré orders are greater than or at least equal to a corresponding minimum frequency.

The minimum frequency may be a cutoff above which the moiré will not be noticeable to a viewer. The minimum frequency may vary depending on the viewing distance of the viewer and the moiré order. In an example, the minimum frequency may be selected based on the equation:

$${f}_{min} = \frac{c}{O} \qquad ( 9 )$$

Where fₘᵢₙ is the minimum frequency, c is a constant, and O is the moiré order. In some examples, the constant may be 80 LPI, 100 LPI, 120 LPI, 150 LPI, 170 LPI, 200 LPI, or the like. For example, for a viewing distance of 30 centimeters (cm), the constant may be 170 LPI. In an example, a minimum frequency may be equal to 1/0.2 mm, or approximately 127 LPI. Moiré patterns of order two may not be noticeable to the human eye at frequencies greater than or at least 85 LPI, and moiré patterns of order three may not be noticeable at frequencies greater than or at least approximately 57 LPI. In other examples, a relationship other than the one specified by equation 9 may exist between the moiré order and the minimum frequency, and a minimum frequency for each moiré order may be selected based on the other relationship, based on observation or experimentation, or the like.

In an example, a first plurality of halftone screens may satisfy equation 7 for all integer coefficients satisfying equation 8, and a second plurality of halftone screens may separately satisfy equation 7 for all integer coefficients satisfying equation 8. The first and second pluralities may have common elements but may not be identical. The combination of the first plurality and the second plurality may not satisfy equation 7 for all integer coefficients satisfying equation 8. For example, a screen set may be designed to have the cyan and magenta halftone screens 231-232 satisfy equation 7 together. In an example, the screen set may be designed to have the cyan, magenta and black halftone screens 231-233 satisfy equation 7 together. The screen set may be designed to have a fourth halftone screen satisfy equation 7 in combination with each of the cyan, magenta and black halftone screens 231-233 individually, but a larger combination including four halftone screens may or may not satisfy equation 7. For example, the viewer may be less sensitive to moiré patterns that include yellow.

In some examples, the DPI may be around 812.8. In an example, the DPI may be around 1625.6 and the first halftone screen, which may be the cyan halftone screen 231, may be a regular screen and have an LPI of approximately 223.29 and an angle of around 15.9 degrees, or around 15.94 degrees. The second halftone screen, which may be the magenta halftone screen 233, may have an LPI of approximately 223.29 and an angle of 74.1 degrees, in some examples having an angle of around 74.06 degrees. The third halftone screen, which may be the black halftone screen 233, may have an LPI of approximately 216.88 and an angle of 45 degrees. Where a fourth halftone screen, such as a yellow screen, is included in the screen set, the fourth screen may have a screen angle of 0 degrees and an LPI of approximately 144. The cyan, and magenta halftone screens 231 and 232 may each have a regularity index of 1, and the black halftone screen may have a regularity index greater than 1. The lower LPI of the cyan halftone screen 231 may cause it to have more dots per cell and thus may allow, for example, for the rendering of smoother skies. The lower LPI of the magenta halftone screen 232 may cause it to have more dots per cell and thus may allow, for example, for the rendering of smoother faces.

In examples, each halftone screen may be represented in a notation referred to as [m, n, tile]. This notation defines a general halftone screen according to the equation:

tile=CellSize\sqrt{m²+n²} (10)

Where CellSize is defined, as in equations (1) and (2), as

$$\frac{DPI}{LPI} .$$

A regular halftone screen further satisfies the equation:

tile=m²+n²

where for a regular screen m is the number of dots of the dot pitch between halftone cell centers in a first direction, for example the x direction, and n is the number of dots of the dot pitch between halftone cell centers in a second direction, for example the y direction. It is to be noted that for an irregular screen, m and n do not represent the distances between halftone cell centers. In such notation and using an example DPI of 1625.6, the screen at 15.94 degrees and LPI of 223.29 may be represented in the [m, n, tile] notation as [2, 7, 53], while the screen at 74.06 degrees with an LPI of 223.29 may be represented as [7, 2, 53]. At the same DPI, the irregular screen at approximately 216.88 and an angle of 45 degrees in [m, n, tile] notation is represented as [5, 5, 53]. In the [m, n, tile] notation, the condition satisfied by a regular screen may be expressed as:

$$\frac{tile}{{m}^{2} + {n}^{2}} = k ,$$

where k is an integer. In example regular halftone screens, m, n and tile are each integers.

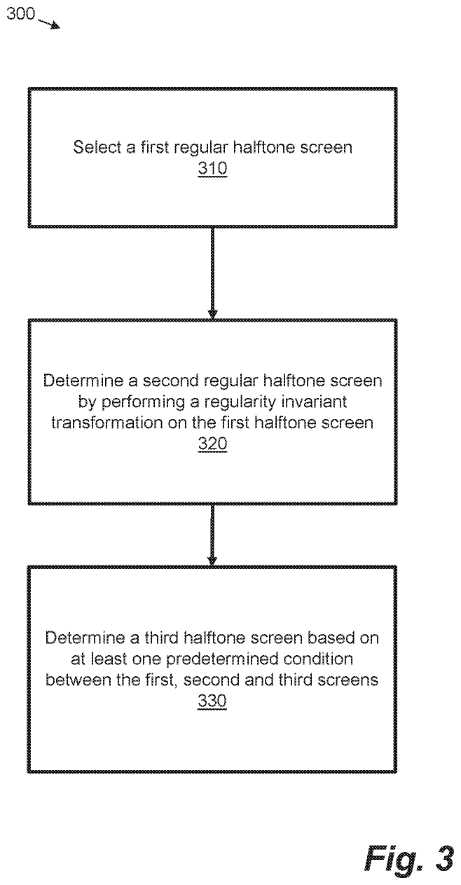

FIG. 3 is a flow diagram of an example method 300 to generate a plurality of regular halftone screens having relatively high LPI, which are smooth and which produce high frequency moiré patterns which are not easily noticeable to viewers. The method 300 may be performed using a processor. In examples, at block 310, the method 300 includes selecting a first halftone screen which is regular. That is, a halftone screen having a regularity index equal to 1. In an example, the first halftone screen is a cyan screen. The first halftone screen may be chosen to have a relatively high LPI. For example, the first halftone screen may have more than or equal to 150, 160, 170, 180, 190, 200, 210, 220, 230, 240 or 250 LPI and may be chosen to have an LPI at least equal to a predetermined threshold. In some examples, the first halftone screen is selected to have an LPI of between approximately 150 and 250. The first halftone screen may have an LPI of approximately 223.29.

In examples, the method at block 310 comprises iterating through LPI and angle values to find a regular screen with an LPI at least equal to a predetermined threshold. In examples, at block 310, the first halftone screen is selected by iterating over a plurality of halftone screens to find a regular halftone screen satisfying a predetermined condition. For example, a large number of halftone screens may be determined to create a pool that can be drawn from to perform additional evaluations. In some examples, the first halftone screen may be chosen by selecting a regular screen with a maximized LPI. In some examples, the first regular screen may be selected to be within a predetermined range of angles centered on a predetermined angle. In examples, each screen of a plurality of screens may be defined by different combinations of differing m, n and tile values, for example the plurality of screens may comprise screens defined by a plurality of m, n and tile values in a range. The first regular halftone screen may then be selected from the plurality of screens by finding screens which are regular by finding screens which satisfy the condition

$$\frac{tile}{{m}^{2} + {n}^{2}} = an integer .$$

In examples, the first regular halftone screen may be selected from a plurality of regular screens defined by integer values of m, integer values of n, and integer values of tile. The method at block 310 may comprise selecting a first regular halftone screen from the plurality of screens based on a predetermined condition, such as a minimum LPI value. In an example, selecting the first regular screen from the plurality of screens comprises selecting a regular screen with the highest LPI. In examples, selecting the first regular halftone screen may comprise selecting a regular screen from the determined plurality of screens based on the LPI value and may comprise selecting a screen with a screen angle within a predetermined range. For example, the first regular halftone screen may be selected from the plurality of screens based on: the LPI value of the screen, and the screen being within 1 degree, or within 2 degrees, from e.g. 15 degrees. In an example, the first halftone screen may be selected as the regular screen with the largest LPI within 1 degree of angle from 15 degrees. In some examples, additional predetermined criteria may be used to determine the plurality of halftone screens. For example, the plurality of halftone screens may be restricted to a predetermined range of LPIs, for example 150 to 250 LPI. The predetermined range of LPIs may be LPIs large enough that the halftone cells will not be noticeable to viewers and small enough that the halftone cells can represent a sufficient number of different color intensities.

Block 320 includes determining a second regular halftone screen starting from the first halftone screen that is selected in block 310. The second regular halftone screen is determined by performing a transformation on the first regular halftone screen under which the screen regularity is invariant. This transformation may be referred to herein as a regularity invariant transformation. A regular halftone screen is produced when a regularity invariant transformation is performed on a regular halftone screen.

In examples, the regularity invariant transformation comprises a rotation of the first regular halftone screen by a particular angle to obtain a second regular halftone screen. In examples, the regularity invariant transformation comprises rotating the first halftone screen by an angle of 90 degrees minus twice the angle of the first regular screen. That is, an orthogonal amplitude modulation screen can be defined by the basis vectors set out in equations (1) and (2) above. In an example, a first regular screen, with index a, has a screen angle of ϕₐ and is defined by basis vectors [symbol] and [symbol] each having two components according to equations (1) and (2). The first screen with index a is regular, the components of the basis vectors, [symbol] and [symbol] , being such that the regularity index of the screen is equal to 1. For such a screen, applying a rotational transformation on the first regular screen a to rotate the screen by an angle of (90−2ϕₐ) degrees results in a second regular screen, with index b, having a screen angle ϕ_{b}. The screen angle ϕ_{b} of the second screen b then satisfies ϕ_{b}=(90−ϕₐ). This rotation by an angle of (90−2ϕₐ) degrees is a regularity invariant transformation which takes the first regular screen and determines a second regular screen from the first regular screen. The LPI value is unchanged by the regularity invariant transformation such that the LPI value of the second regular screen is equal to that of the first regular screen.

In an example, the DPI of the dot pitch is around 1625.6 and the first screen is a regular screen at an angle of 15.94 degrees and is rotated by (90−(2×15.9)) degrees to obtain the second screen, at an angle of 74.06 degrees. In another example, the DPI of the dot pitch is 1625.6, the first regular screen is at an angle of 33.69 degrees, the second regular screen is at an angle of 56.31 and both the first and second screens have an LPI of 225.43. In examples, the regularity invariant transformation is such that the difference in angle between the first halftone screen and the second halftone screen is such that a moiré condition is satisfied. For example, a plurality of moiré frequencies may be computed for each of the set of regular screens with the first regular screen. A screen from the set of screens for which each moiré frequency between that screen and the first screen is greater than a predetermined threshold may be chosen as the second screen. The first screen and the second screen may satisfy a high frequency moiré condition. For example, the first and second screens may satisfy equation (7) and equation (8) up to a predetermined moiré order, for example a moiré order of 6. In an example, the method 300 may generate the first and second regular halftone screens 231 and 232 of FIG. 2.

The example method of FIG. 3 includes, at block 330, selecting a third halftone screen comprises obtaining a screen set comprising first, second and third halftone screens. The third screen may be selected based on one or more conditions imposed on the third screen and/or the screen set comprising the first, second and third screens. In examples, a screen is evaluated to determine whether the screen meets one or more conditions, such as having a regularity index less than or equal to a predetermined threshold, and/or the screen set comprising the screen and the first and second screens satisfies one or more conditions such as a high frequency moiré condition or a rosette size with a diameter less than or equal to a predetermined threshold, for example 0.24 mm.

In example methods, a first regular halftone screen is selected; a second regular halftone screen is determined by performing a regularity invariant transformation on the first halftone screen; and a third halftone screen is selected based on a predetermined condition being satisfied between the first, second and third halftone screens. A screen set produced by such an example method therefore may comprise two regular screens which are chosen to have high LPI values, and therefore provide for a high degree of smoothness in an image. The use of two regular screens may also produce low amounts of quantization noise due to the regularity of the screens. In examples, the use of a regularity invariant transformation may provide for finding a second regular screen when starting from a first regular screen. This may be useful for determining a regular screen with a high LPI value since relatively few regular screens are available at higher LPI values when compared to at lower LPI values. In examples, the regularity invariant transformation performed on the first screen is a rotation by an angle of 90 degrees minus two times the screen angle of the first screen, this transformation provides for the first and second screens being separated by angle which may be sufficient to minimize visible interference patterns. In examples, where the third screen is chosen to satisfy a predetermined condition, the condition may result in the first, second, and third screens producing minimal amounts of visible moiré interference. In examples, the third screen may be chosen to have a high LPI value and a low regularity index value, which also provides for a high degree of smoothness and low quantization noise. As such, in examples, a screen set comprising three screens with a high degree of regularity, and thus amounts low quantization noise; high LPI values, and thus a high degree of smoothness; and in some examples producing minimal amounts of visible moiré interference.

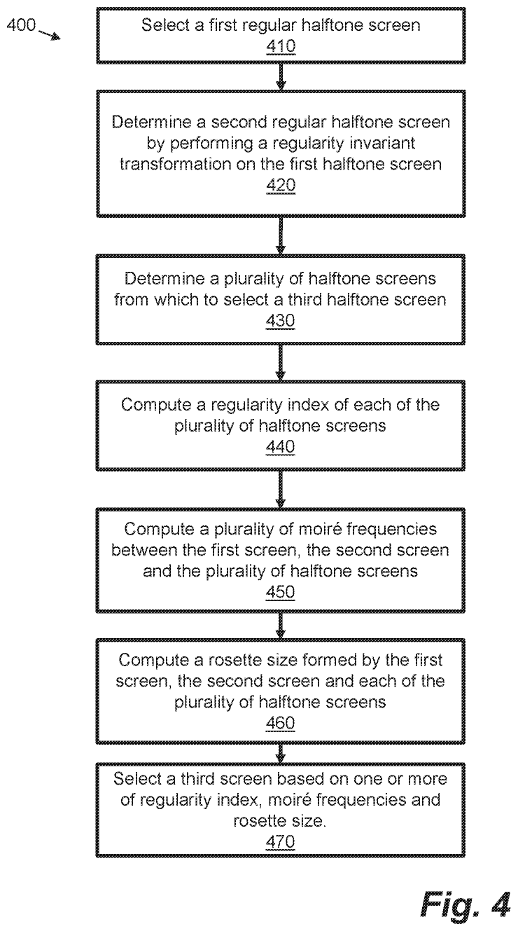

FIG. 4 is a flow diagram of a method of producing a screen set comprising a plurality of screens having relatively high LPI, wherein the screen set produces high frequency moiré patterns which are not easily noticeable to viewers and wherein two screens of the screen set are regular. The method 400 may be performed using a processor. Block 410 and 420 may be performed as described for blocks 310 and 320 in the example method of FIG. 3.

In an example, at block 430 a plurality of halftone screens from which to select a third halftone screen is determined. At block 440 a regularity index, for example according to equation (4), for each of the plurality of halftone screens from which to select a third halftone screen is computed. Block 440 may include determining whether the regularity index for each of the plurality of halftone screens is less than or equal to a predetermined threshold. A predetermined threshold for the regularity index may be, for example, 1, 2, 4, 5, 10, 20, or the like.

At block 450, a moiré condition is evaluated to select the third screen. In this example, a moiré condition may be evaluated for the screen set comprising the first screen, the second screen and each of the plurality of halftone screens from which to select the third screen. Evaluating the moiré condition may comprise evaluating whether it is true that the halftone screen set comprising the first screen, the second screen and one of the plurality of screens forms moiré frequency vectors for each of a plurality of moiré orders having a minimum frequency at or equal to a predetermined threshold frequency. In examples, the minimum frequency may be any frequency which allows moiré effects not to be visible to a user, for example, any of the frequencies set out above.

At block 460, in an example, a dimension, for example a diameter, of the rosette pattern formed by each of the first screen, second screen and a screen to be selected as the third screen is computed. At block 470, the third screen is selected from the plurality of screens. In an example, a maximum diameter of rosette size for the halftone screen set is used as a condition for selecting the third screen. In an example, imposing this condition comprises imposing the condition | [symbol] − [symbol] |=dₘₐₓ for each screen in the screen set; where dₘₐₓ is the maximum allowable diameter for the rosette size and [symbol] and [symbol] are the frequency vectors for a screen with index i. In an example, dₘₐₓ may be equal to approximately 0.3 mm or 0.4 mm, or 0.5 mm or 0.24 mm.

In examples, the third screen may be selected by implementing a process which determines a screen which satisfies one or more conditions, such as conditions based on computations described with reference to blocks 440, 450 and 460. For example, a method may determine a screen which has a regularity index at or below a predetermined threshold. A method may select a screen which forms moiré frequencies for a predetermined number of moiré orders equal to or greater than a predetermined threshold. A method may select a screen which produces rosettes with a diameter which is less than or equal to a predetermined threshold, which may be, for example, 0.24 mm. It is to be understood that in examples the method may not comprise all of blocks 440 to 460 or may comprise any one or more of these blocks in any order. In examples, a method may comprise taking one or more conditions and finding a halftone screen to select as the third halftone based on these conditions, in some examples this may be referred to as a ‘greedy algorithm’. For example, any one or more of a range of LPI values, a maximum regularity index, a minimum moiré frequency for a predetermined moiré order and a maximum rosette diameter may be specified as conditions and the method “may find a third screen satisfying these conditions. In an example, the third screen is determined by finding a third screen which, when taken together with the first and the second screens, results in a rosette size of <0.24 mm.

In examples, any other method suitable for finding a third screen satisfying the first, second and third conditions may be used. The method 400 may include computing rational number representations of horizontal and vertical distances between adjacent halftone cells in a halftone screen. As used herein, the terms “horizontal” and “vertical” refer to first and second directions along the dot grid. The horizontal and vertical directions may be orthogonal in some examples. The rational number representations may be computed according to equations 1-3 in an example. The horizontal and vertical distances may be first and second components of a basis vector.

Computing a regularity index, for example at block 440, may include determining a least common multiple of denominators of the horizontal and vertical distances. For example, the least common multiple may be computed according to equation (4). For example, block 430 may be performed for a plurality of halftone screens, and each halftone screen may be compared to the predetermined regularity index. The predetermined regularity index may be 1, 2, 4, 5, 10, 20, or the like. In some examples, the plurality of halftone screens may be restricted to a predetermined range of LPIs, for example the LPI for each screen may be restricted to being greater than or equal to a predetermined threshold. In an example, the plurality of halftone screens may be determined by selecting a least common multiple, determining a corresponding set of denominators, and determining all basis vectors in the range of LPIs having denominators in the set.

The method 400 may include determining a plurality of fundamental frequency vectors based on an inverse of a halftone cell size and an angle of each halftone screen. For example, the plurality of fundamental frequency vectors may be determined according to equations 5 and 6. The fundamental frequency vectors may be determined for the first and second halftone screens, and one of the plurality of halftone screens from which the third halftone screen is to be selected.

Computing a moiré condition on the screen set, for example at block 450, may include computing all linear combinations of the fundamental frequency vectors that have integer coefficients with an absolute sum less than a predetermined moiré order threshold. As used herein, the term “absolute sum” refers to a sum of absolute values. All linear combinations may be computed for the first screen, second screen and one of the plurality of halftone screens from which the third halftone screen is to be selected. In an example, the linear combinations of fundamental frequency vectors may be computed according to the summation in equation 7, and the integer coefficients with an absolute sum less than a predetermined moiré order threshold may be determined according to equation 8.

Computing a moiré condition on the screen set, for example at block 450, may include calculating a plurality of moiré frequencies based on a magnitude of each linear combination. In some examples, computing a moiré condition, such as at block 450, may include determining whether each moiré frequency of a first order is greater than a first predetermined frequency threshold and each moiré frequency of a second order is greater than a second predetermined frequency threshold. For example, the first and second predetermined frequency thresholds may be selected according to equation 9, e.g., using a constant of 80 LPI, 100 LPI, 120 LPI, 150 LPI, 170 LPI, 200 LPI, etc. Thus, in an example, the first order may be two; the first predetermined threshold may be 85 LPI, the second order may be three; and the second predetermined threshold may be approximately 57 LPI.

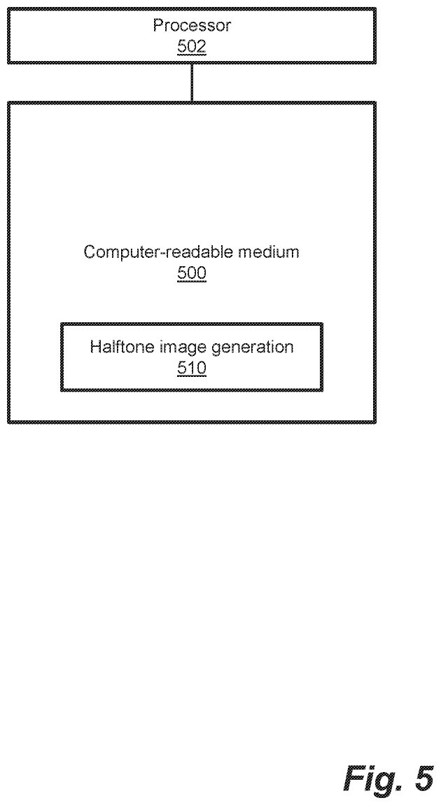

FIG. 5 is a block diagram of an example computer-readable medium 500 including instructions that, when executed by a processor 502, cause the processor 502 to generate a plurality of halftone images based on a plurality of halftone screens. The computer-readable medium 500 may be a non-transitory computer readable medium, such as a volatile computer readable medium (e.g., volatile RAM, a processor cache, a processor register, etc.), a non-volatile computer readable medium (e.g., a magnetic storage device, an optical storage device, a paper storage device, flash memory, read-only memory, non-volatile RAM, etc.), and/or the like. The processor 502 may be a general purpose processor or special purpose logic, such as a microprocessor, a digital signal processor, a microcontroller, an ASIC, an FPGA, a programmable array logic (PAL), a programmable logic array (PLA), a programmable logic device (PLD), etc.

The computer-readable medium 500 may include a halftone image generation module 510. As used herein, a “module” is a set of instructions that when executed or interpreted by a processor or stored at a processor-readable medium realizes a component or performs a method. The halftone image generation module 510 may cause the processor 502 to generate a plurality of halftone images based on a plurality of halftone screens. For example, the halftone image generation module 510 may cause the processor 502 to receive image data indicating color intensities at various locations in an image. The halftone image generation module 510 may cause the processor 502 to use the plurality of halftone screens to generate a plurality of halftone images from the image data. Referring to FIG. 1, the halftone image generation module 510, when executed by the processor 502, may realize, for example, the color engine 110 or the halftone engine 120.

Each halftone screen may include a vertical distance and a horizontal distance between neighboring halftone cell centers. The vertical and horizontal distances may each exactly or approximately equal an integer multiple of a dot pitch. Numbers may be approximately equal if they differ by no more than 0.1%, 0.5%, 1%, 2%, 5%, or the like. The neighboring halftone cell centers may be from any neighboring halftone cells. As used herein, the term “neighboring” refers to a first halftone cell and a second halftone cell nearest the first halftone cell. Two halftone cells may be neighboring even if one has multiple equidistant neighbors. The dot pitch may be that of a printer for which the halftone images are generated.

The halftone screen set may form a high frequency moiré pattern. For example, all moiré frequencies for the first subset may be above a predetermined threshold. The moiré frequencies may be computed according to equation 7 based on the halftone screens in the first subset in an example. A second subset of the plurality of halftone screens different from the first may also form a high frequency moiré pattern. The second subset may include halftone screens from the first subset but may not be identical to the first subset. All moiré frequencies for the second subset may be above a predetermined threshold in an example. The predetermined threshold for the second subset may be the same as or different from the predetermined threshold for the first subset.

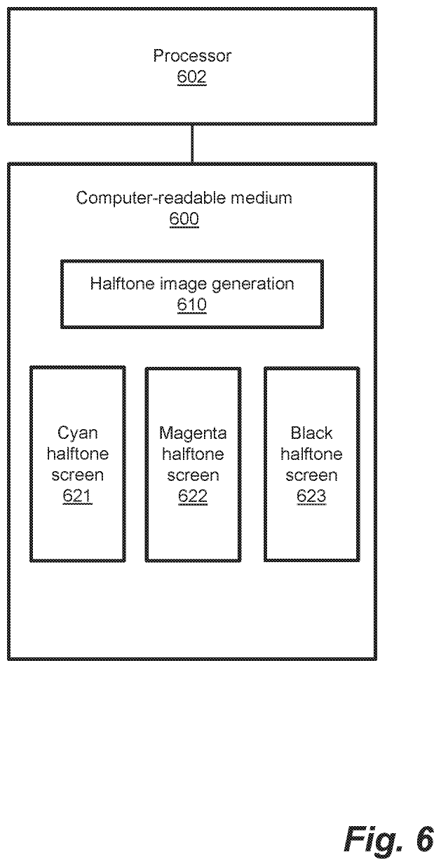

FIG. 6 is a block diagram of an example computer-readable medium 600 including instructions that, when executed by a processor 602, cause the processor 602 to generate a plurality of halftone images based on a plurality of halftone screens 621-623. The computer-readable medium 600 may include a halftone image generation module 610. The halftone image generation module 610 may cause the processor 602 to generate a plurality of halftone images based on the plurality of halftone screens 621-623. Referring to FIG. 2, the halftone image generation module 610, when executed by the processor 602, may realize, for example, the color engine 210 or the halftone engine 220. In the illustrated example, the computer-readable medium 600 may include a cyan halftone screen 621, a magenta halftone screen 622, and a black halftone screen 623. The computer-readable medium in some examples may further comprise a yellow halftone screen. In other examples, the computer-readable medium 600 may include more or fewer halftone screens and may include halftone screens for colors besides cyan, magenta, black, and yellow.

In an example, a halftone screen in the first subset may include a cell size at least 50% larger than that of another halftone screen in the first subset. For example, the cell sizes may be varied to create the high frequency moiré pattern, to be able to render more color intensities, or the like. In some examples, the magenta halftone screen 623 may have a cell size at least 50% larger than that of the cyan halftone screen 622 or vice versa. The halftone screen with the larger cell size may be selected based on an image to be rendered or characteristics of images expected to be rendered.

In an example for a printer with a DPI of 1625.6, the black halftone screen 621 may have an LPI of 225 and a screen angle of 34 degrees. The cyan screen may have an LPI of approximately 223.29 and an angle of 15.9 degrees. The magenta halftone screen 233 may have an LPI of approximately 223.29 and an angle of 74.1 degrees. The black halftone screen 233 may have an LPI of approximately 216.88 and an angle of 45 degrees which in [m, n, tile] notation is represented as [5, 5, 53]. The cyan and magenta halftone screens 621, 622 are regular halftone screens in an example, and the black halftone screen 623 may be a regular or irregular halftone screen. may each have horizontal and vertical distances each exactly or approximately equal to an integer multiple of a dot pitch. Additional halftone screens, such as a yellow halftone screen may be regular or irregular halftone screens.

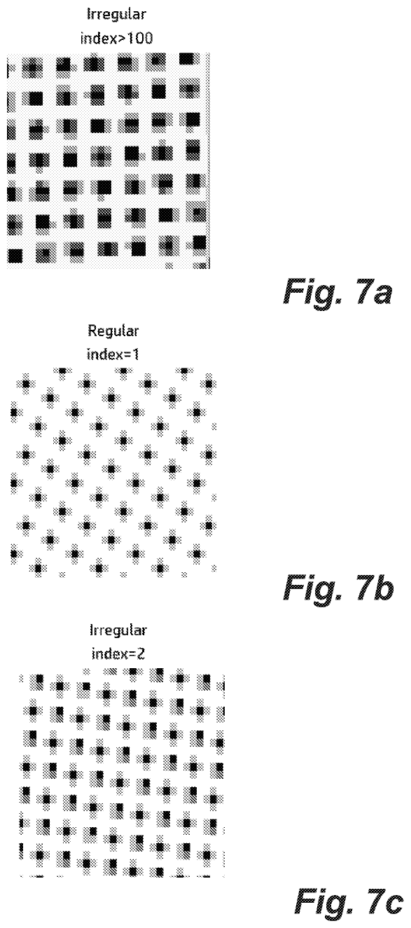

FIGS. 7a-7c show examples of halftone screens having different values of regularity index. From these figures, the noise effect of quantization error between the halftone cells of a screen and the dot pitch can be seen. FIG. 7a shows an example irregular halftone screen having a regularity index >100, in this example having a regularity index equal to 784. FIG. 7b shows an example regular halftone screen having a regularity index of 1. FIG. 7c shows an example irregular halftone screen having a regularity index equal to 2.

The above description is illustrative of various principles and implementations of the present disclosure. Numerous variations and modifications will become apparent to those skilled in the art once the above disclosure is fully appreciated. Accordingly, the scope of the present application should be determined only by the following claims.

What is claimed is:

1. A method comprising:
selecting a first regular halftone screen;
determining a second regular halftone screen, using a processor, by performing a regularity invariant transformation on the first regular halftone screen; and
determining a third halftone screen to form a halftone screen set comprising the first screen, the second screen and the third screen, wherein the third halftone screen is determined based on at least one predetermined condition being satisfied between the first, second and third halftone screens.

2. The method according to claim 1 wherein the regularity invariant transformation performed on the first regular halftone screen to determine the second regular halftone screen is a rotation by an angle of 90 degrees minus twice the screen angle of the first regular halftone screen.

3. The method according to claim 1 wherein selecting the first halftone screen comprises iterating over a plurality of screens until a screen is found having a regularity index equal to 1 and having a number of lines per inch within a predetermined range.

4. The method according to claim 1 wherein the third halftone screen is determined based on a condition that each of a plurality of moiré frequencies between the first, second and third halftone screens is above a predetermined threshold.

5. A method according to claim 1 wherein the third halftone screen is determined based on a computed regularity index of the third halftone screen being less than or equal to a predetermined threshold.

6. A method according to claim 1 wherein the third halftone screen is determined based on a computed rosette size formed by the first screen, the second screen and the third screen having a diameter less than or equal to a predetermined threshold.

7. A non-transitory computer-readable medium comprising instructions that, when executed by a processor, cause the processor to:
generate a plurality of halftone images using a halftone screen set comprising a first halftone screen, a second halftone screen and a third halftone screen;
wherein each of a first screen and a second screen of the halftone screen set includes a vertical distance and a horizontal distance between neighboring halftone cell centers, the vertical and horizontal distances each equal to a first integer multiple of a dot pitch, and
the first screen is a regular screen and is related to the second screen by a transformation which maintains regularity when performed on a regular screen;
and wherein the third screen is such that a predetermined condition between the first screen, the second screen and the third screen is satisfied.

8. A computer-readable medium according to claim 7 wherein the second screen is related to the first screen by a rotational transformation by an angle of 90 degrees minus two times the screen angle of the first screen.

9. A computer-readable medium according to claim 7 wherein the halftone screen set forms moiré frequency vectors for each of a plurality of moiré orders having a minimum frequency at or equal to a predetermined threshold frequency, wherein a moiré frequency vector is a linear combination of fundamental frequency vectors of each the halftone screens which the halftone screen set comprises multiplied by integer coefficients, wherein a moiré order is a sum of absolute values of the integer coefficients, and wherein a fundamental frequency vector includes a first component proportional to an inverse of a cell size multiplied by a cosine of a screen angle relative to a dot grid and a second component proportional to the inverse of the cell size multiplied by a sine of the screen angle.

10. A computer-readable medium according to claim 7 wherein the third halftone screen has a regularity index less than or equal to a predetermined threshold.

11. A computer-readable medium according to claim 7 wherein the halftone screen set has a rosette having a diameter less than or equal to 0.24 mm.

12. A computer-readable medium according to claim 7 wherein:
the dot grid has a number of dots per inch of 1625.6;
the first screen has an angle of approximately 15.9 degrees and a number of lines per inch of approximately 223.29;
the second screen has an angle of approximately 74.1 degrees and a number of lines per inch of approximately 223.29; and
the third screen has an angle of approximately 45 degrees and a number of lines per inch of approximately 216.88.

13. A system, comprising:
a color engine to separate an image into a plurality of color components; and
a halftone engine to generate a plurality of halftone images based on the plurality of color components and a plurality of halftone screens; wherein
the plurality of halftone screens comprises a first halftone screen, a second halftone screen and a third halftone screen; and wherein
each of the first halftone screen and the second halftone screen has a regularity index equal to 1, wherein the regularity index of a screen is a least common multiple of denominators of components of a basis vector of the screen, and wherein a first component of the basis vector is calculated based on a cell size multiplied by a cosine of a screen angle relative to a dot grid, and a second component of the basis vector is calculated based on the cell size multiplied by a sine of the screen angle;
the first halftone screen and the second halftone screen are related by a regularity invariant transformation; and
the third halftone screen satisfies a predetermined condition between the first, second and third halftone screens.

14. The system according to claim 13 wherein the regularity invariant transformation is a rotation by an angle of 90 degrees minus two times the screen angle of the first screen.

15. The system according to claim 13 wherein the plurality of halftone screens forms a high frequency moiré pattern when the halftone screens are overlaid on each other.

16. The system according to claim 13 wherein the third halftone screen of the halftone screen set has a regularity index less than or equal to a predetermined threshold.

17. The system according to claim 13 wherein the halftone screen set produces a rosette having a diameter less than or equal to a predetermined threshold.

18. The system according to claim 13 wherein the first screen is a cyan screen, the second screen is a magenta screen and the third screen is a black screen.
